(19) United States
(12) Patent Application Publication
(10) Pub. No.: US 2023/0369992 A1
(43) Pub. Date: Nov. 16, 2023

(54) ELECTROSTATIC ACTUATOR

(71) Applicants: Seiki CHIBA, Meguro-ku, Tokyo (JP); Mikio WAKI, Sakura-shi, Tochigi (JP); ZEON CORPORATION, Chiyoda-ku, Tokyo (JP)

(72) Inventors: Seiki CHIBA, Meguro-ku, Tokyo (JP); Mikio WAKI, Sakura-shi, Tochigi (JP)

(73) Assignees: Seiki CHIBA, Meguro-ku, Tokyo (JP); Mikio WAKI, Sakura-shi, Tochigi (JP); ZEON CORPORATION, Chiyoda-ku, Tokyo (JP)

(21) Appl. No.: 18/245,160

(22) PCT Filed: Aug. 26, 2021
(86) PCT No.: PCT/JP2021/031413

§ 371 Date: Mar. 14, 2023

(30) Foreign Application Priority Data
Sep. 28, 2020 (JP) 2020-161620

(51) Int. Cl. H02N 1/00

(52) U.S. Cl. CPC H02N 1/004

(57) ABSTRACT

An electrostatic actuator A1 includes a stator 1 and a mover 2, and is driven by an attractive force and a repulsive force generated by an electric field between the stator 1 and the mover 2. One of the stator 1 and the mover 2 includes a plurality of capacitor structures 5 each having a counter electrode 51 and a non-counter electrode 52. The other one of the stator 1 and the mover 2 includes a plurality of counter electrodes 61. The electrostatic actuator A1 is driven by an attractive force and a repulsive force generated between the counter electrodes 51 and the counter electrodes 61. This configuration can provide a faster and higher-power electrostatic actuator.

### TECHNICAL FIELD

The present invention relates to an electrostatic actuator.

### BACKGROUND ART

Various actuators, such as electric motors and hydraulic cylinders, have been proposed as a drive source for generating a drive force. Patent document 1 discloses an electrostatic motor, which is an example of an actuator. The electrostatic motor illustrated in Patent Document 1 includes a stator and a rotor. Each of the stator and the rotor has a plurality of counter electrodes. The polarities of the counter electrodes of the stator and the polarities of the electrodes of the rotor are switched individually and sequentially to generate an attractive force and a repulsive force between the electrodes. These forces are utilized to rotate the rotor and generate a rotational force which serves as a drive force.

### PRIOR ART DOCUMENT

Patent Document
Patent Document 1: JP-A-2007-97277

### SUMMARY OF THE INVENTION

### Problem to be Solved by the Invention

However, in order to increase the rotational speed according to the rotational force obtained by the electrostatic motor, it is necessary to switch the polarities of the counter electrodes at high speed. Furthermore, in order to increase the output of the rotational force obtained by the electrostatic motor, it is necessary to increase the charge of the counter electrodes. In a conventional electrostatic motor, a stator and a rotor are arranged apart from each other, and are each provided with a plurality of electrodes. One electrode of the stator and one electrode of the rotor form a pair of electrodes, which are arranged apart from each other to form a capacitor structure. With this configuration, however, it is hard to make the pair of electrodes have the same polarity, thus making it difficult to utilize the repulsive force. A possible solution for solving the problem is to delay the polarity change with a resistor or the like, but the delay of the polarity change hinders high-speed driving, resulting in an increase in loss. Furthermore, since the positional relationship of the pair of electrodes that form a capacitor changes constantly, the state where the electrodes entirely overlap with each other to have the largest charge is achieved only for a moment, which makes it difficult to obtain a large force.

The present invention has been proposed under the above-noted circumstances, and an object thereof is to provide a faster and higher-power electrostatic actuator.

### Means to Solve the Problem

According to the present invention, there is provided an electrostatic actuator including a stator and a mover, the electrostatic actuator being driven by an attractive force and a repulsive force generated by an electric field between the stator and the mover. One of the stator and the mover includes a plurality of first capacitor structures each having a first counter electrode and a first non-counter electrode. The other one of the stator and the mover includes a plurality of second counter electrodes. The electrostatic actuator is driven by an attractive force and a repulsive force generated between the first counter electrodes and the second counter electrodes.

In a preferred embodiment of the present invention, the other one of the stator and the mover includes a plurality of second capacitor structures each having a second non-counter electrode and a different one of the second counter electrodes.

In a preferred embodiment of the present invention, the electrostatic actuator includes a rotational shaft that outputs a drive force. The mover has a circular shape as viewed along an axial direction of the rotational shaft, and is fixed to the rotational shaft. The stator has a cylindrical shape with the rotational shaft as a central axis, and surrounds the mover. The plurality of first capacitor structures and the plurality of second counter electrodes are arranged in circles centering on the rotational shaft, so that the first counter electrodes and the second counter electrodes face each other.

In a preferred embodiment of the present invention, the stator has a shape extending in a first direction. The mover has a dimension smaller than the stator in the first direction, and is arranged to face the stator in a second direction perpendicular to the first direction. The plurality of first capacitor structures and the plurality of second counter electrodes are arranged along the first direction so that the first counter electrodes and the second counter electrodes face each other.

### Advantages of the Invention

The present invention provides a faster and higher-power electrostatic actuator.

Other features and advantages of the present invention will be more apparent from the detailed description given below with reference to the accompanying drawings.

### BRIEF DESCRIPTION OF THE DRAWINGS

FIG. 1 is a schematic perspective view illustrating an electrostatic actuator according to a first embodiment of the present invention.

FIG. 2 is a cross-sectional view illustrating the electrostatic actuator according to the first embodiment of the present invention.

FIG. 3 shows the electrostatic actuator according to the first embodiment of the present invention, where (a) is an enlarged cross-sectional view illustrating a main part of an example of the electrostatic actuator, (b) is an enlarged cross-sectional view illustrating a main part of another example of the electrostatic actuator, and (c) is an enlarged cross-sectional view illustrating a main part of yet another example of the electrostatic actuator.

FIG. 4 illustrates the configuration of an actuator system using the electrostatic actuator according to the first embodiment of the present invention.

FIG. 5 is a cross-sectional view illustrating an operational example of the electrostatic actuator according to the first embodiment of the present invention.

FIG. 6 is a cross-sectional view illustrating an operational example of the electrostatic actuator according to the first embodiment of the present invention.

FIG. 7 is a cross-sectional view illustrating a first variation of the electrostatic actuator according to the first embodiment of the present invention.

FIG. 8 illustrates the configuration of an actuator system using the first variation of the electrostatic actuator according to the first embodiment of the present invention.

FIG. 9 is a cross-sectional view illustrating a second variation of the electrostatic actuator according to the first embodiment of the present invention.

FIG. 10 illustrates the configuration of an actuator system using the second variation of the electrostatic actuator according to the first embodiment of the present invention.

FIG. 11 illustrates the configuration of an actuator system using a third variation of the electrostatic actuator according to the first embodiment of the present invention.

FIG. 12 is a cross-sectional view illustrating an electrostatic actuator according to a second embodiment of the present invention.

### MODE FOR CARRYING OUT THE INVENTION

Preferred embodiments of the present invention are described below with reference to the accompanying drawings.

The terms such as “first”, “second”, and “third” in the present disclosure are used merely as labels and not intended to impose orders on the elements accompanied with these terms.

### First Embodiment

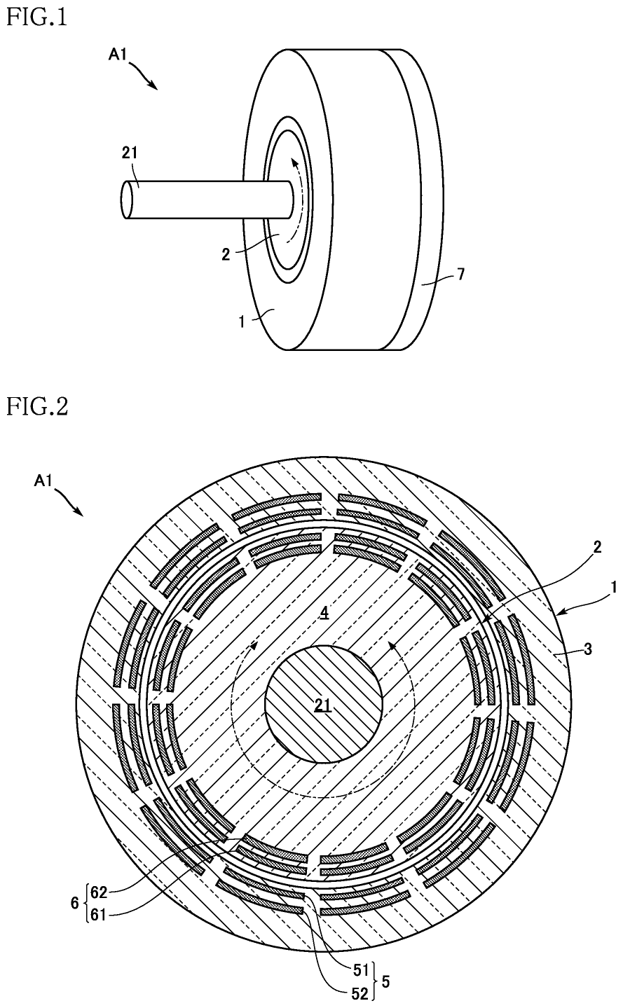

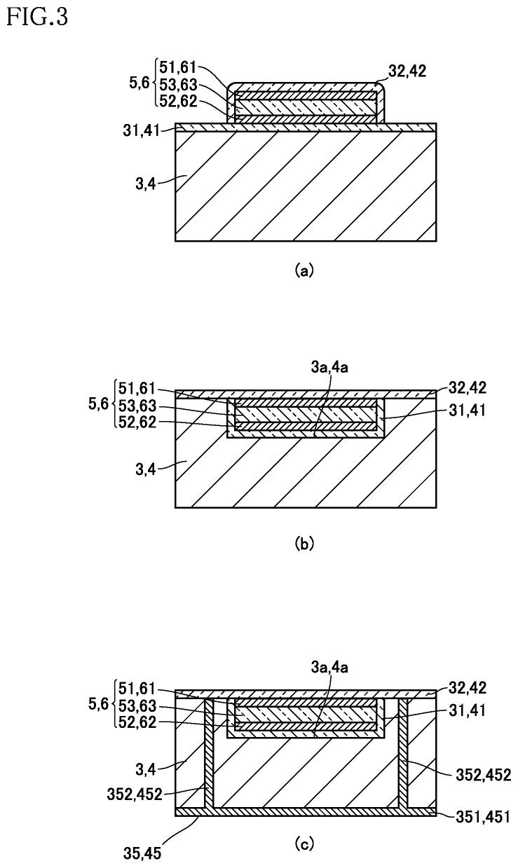

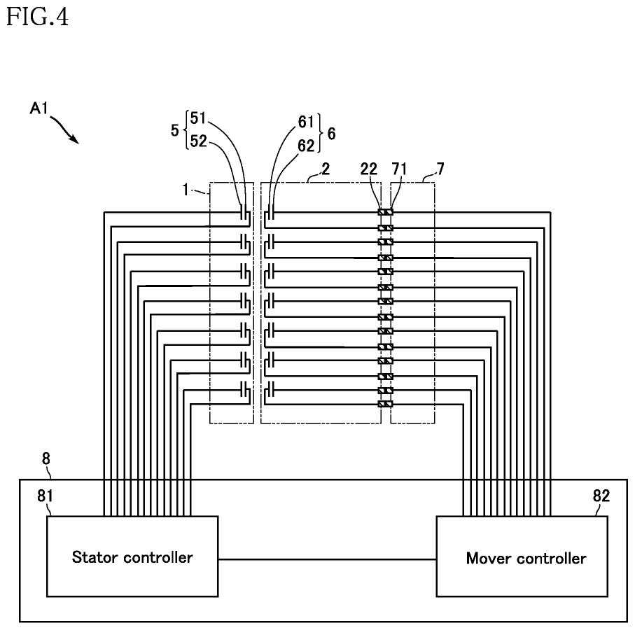

FIGS. 1 to 4 show an electrostatic actuator according to a first embodiment of the present invention. An electrostatic actuator A1 of the present embodiment includes a stator 1, a mover 2, and a power receiver 7. The electrostatic actuator A1 is a motor actuator, which is an example of an actuator, and generates a rotational force. FIG. 1 is a schematic perspective view illustrating the electrostatic actuator A1. FIG. 2 is a cross-sectional view illustrating a cross section that is perpendicular to the axial direction of a rotational shaft 21 (described below). FIG. 3 shows the electrostatic actuator A1, where (a) is an enlarged cross-sectional view illustrating a main part of an example of the electrostatic actuator A1, (b) is an enlarged cross-sectional view illustrating a main part of another example of the electrostatic actuator A1, and (c) is an enlarged cross-sectional view illustrating a main part of yet another example of the electrostatic actuator A1. FIG. 4 illustrates the configuration of an actuator system using the electrostatic actuator A1.

The stator 1 is a member that, for example, is fixed to the periphery of a portion at which the electrostatic actuator A1 is installed. In the present embodiment, the stator 1 includes a support 3 and a plurality of capacitor structures 5.

The support 3 forms most of the external appearance of the stator 1, and supports the capacitor structures 5. The material of the support 3 is not particularly limited, and may be metal or resin as appropriate. In the present embodiment, the support 3 has a cylindrical shape.

The capacitor structures 5 are arranged side by side. In the present embodiment, the capacitor structures 5 are arranged side by side circumferentially at a portion of the support 3 located inward in the radial direction. As shown in FIGS. 2 and 3, each of the capacitor structures 5 has a counter electrode 51, a non-counter electrode 52, and a dielectric layer 53. The counter electrode 51 is arranged inward in the radial direction and faces the mover 2. The non-counter electrode 52 is arranged outward in the radial direction and located opposite to the mover 2 with the counter electrode 51 therebetween. The dielectric layer 53 is sandwiched between the counter electrode 51 and the non-counter electrode 52 and made of a dielectric.

The material of the counter electrode 51 and the non-counter electrode 52 is not particularly limited. For example, each of the electrodes may be made of a metal layer or a carbon-containing layer as appropriate. The material of the dielectric layer 53 is not particularly limited, and may be resin or elastomer. The capacitor structure 5 may have any configuration as long as the counter electrode 51 and the non-counter electrode 52 can be charged as intended during the operation of the electrostatic actuator A1 described below.

FIGS. 3(a) to 3 (c) each show an enlarged view of the detailed structures of the stator 1 and the mover 2, where the stator 1 and the mover 2 are denoted by the corresponding reference signs. In each of the figures, the stator 1 and the mover 2 have different orientations along the radial direction. In the description of the stator 1, the upper side in FIGS. 3(a), 3(b) and 3(c) corresponds to the radially inward side, and the horizontal direction in FIGS. 3(a), 3(b) and 3(c) corresponds to the circumferential direction.

In the example shown in FIG. 3(a), an insulating layer 31 is provided on the inner circumferential surface of the support 3. The insulating layer 31 insulates the support 3 and the capacitor structure 5 from each other. If the support 3 is made of an insulating material, the insulating layer 31 may be omitted. The material of the insulating layer 31 is not particularly limited. For example, the insulating layer 31 may be made of resin. The capacitor structure 5 is provided on the insulating layer 31, where the non-counter electrode 52, the dielectric layer 53, and the counter electrode 51 are stacked in the stated order from the outer side in the radial direction. In the illustrated example, the capacitor structure 5 is covered with a protective layer 32. Positioned between the capacitor structure 5 and a capacitor structure 6, the protective layer 32 takes a charged state, and insulates and protects the capacitor structure 5. The material of the protective layer 32 is not particularly limited. For example, the protective layer 32 may be made of resin. It is preferable that the protective layer 32 be made of a material having a dielectric constant equal to or greater than each of the dielectric layer 53 and a dielectric layer 63 and having an insulating property equal to or greater than each of the insulating layer 31 and an insulating layer 41.

In the example shown in FIG. 3(b), a recess 3a is provided in a portion of the support 3 located inward in the radial direction. The recess 3a is recessed from the inner circumferential surface of the support 3. The recess 3a accommodates the capacitor structure 5 with the insulating layer 31 provided therebetween. The order of stacking the layers of the capacitor structure 5 is the same as the order shown in FIG. 3(a). The protective layer 32 is provided to cover the inner circumferential surface of the support 3 and the counter electrode 51.

In the example illustrated in FIG. 3(c), the support 3 has an electric field shielding portion 35. The electric field shielding portion 35 is made of a material capable of shielding the electric field of, for example, a metal. In the illustrated example, the electric field shielding portion 35 has a bottom portion 351 and a plurality of walls 352. The bottom portion 351 is provided behind the capacitor structure 5 (downward in the figure), and extends in the direction in which the plurality of capacitor structures 5 are aligned. Each of the walls 352 is provided between adjacent capacitor structures 5, and has a lower end connected to the bottom portion 351. In other words, each of the capacitor structures 5 is arranged between two walls 352. A support 4 has an electric field shielding portion 45 having the same configuration as the electric field shielding portion 35. The electric field shielding portion 45 has a bottom portion 451 and a plurality of walls 452. Such a configuration can suppress the situation where electric field noise that may occur from the capacitor structures 5 and capacitor structures 6 is leaked to the surroundings. The electric field shielding portion 35 and the electric field shielding portion 45 may be connected to the ground, or may not be connected to either the ground or a power source.

The mover 2 rotates with respect to the stator 1. The mover 2 of the present embodiment includes a rotational shaft 21, the support 4, and the capacitor structures 6. The mover 2 can freely rotate at the inner side of the stator 1 in the radial direction. To realize such a configuration, the stator 1 and the mover 2 may be separated from each other by a gap. Alternatively, an insulating fluid such as oil may be provided between the stator 1 and the mover 2.

The support 4 forms most of the external appearance of the mover 2, and supports the capacitor structures 6. The material of the support 4 is not particularly limited, and may be metal or resin as appropriate. In the present embodiment, the support 4 has a cylindrical shape. The rotational shaft 21 is attached to the center of the support 4, and outputs the rotational force of the electrostatic actuator A1. The rotational shaft 21 is a round bar made of metal, for example.

The capacitor structures 6 are arranged side by side. In the present embodiment, the capacitor structures 6 are arranged side by side circumferentially at a portion of the support 4 located inward in the radial direction. As shown in FIGS. 2 and 3, each of the capacitor structures 6 has a counter electrode 61, a non-counter electrode 62, and a dielectric layer 63. The counter electrode 61 is arranged outward in the radial direction, and faces the counter electrode 51 of the stator 1. The non-counter electrode 62 is arranged inward in the radial direction and located opposite to the stator 1 with the counter electrode 61 therebetween. The dielectric layer 63 is sandwiched between the counter electrode 61 and the non-counter electrode 62 and made of a dielectric.

The material of the counter electrode 61 and the non-counter electrode 62 is not particularly limited. For example, each of the electrodes may be made of a metal layer or a carbon-containing layer as appropriate. The material of the dielectric layer 63 is not particularly limited, and may be resin or elastomer. The capacitor structures 6 may have any configuration as long as the counter electrodes 61 and the non-counter electrodes 62 can be charged as intended during the operation of the electrostatic actuator A1 described below. It is preferable that the counter electrodes 61, the non-counter electrodes 62, and the dielectric layers 63 be as thin as possible within a range where a normal pressure resistance is maintained.

In the description of the mover 2, the upper side in FIGS. 3 (a), (b) and (c) corresponds to the radially outward side, and the horizontal direction in FIGS. 3(a), (b) and (c) corresponds to the circumferential direction. The specific examples of the mover 2 shown in FIGS. 3 (a), (b), and (c) are similar to those of the stator 1 described above. An insulating layer 41 corresponds to the insulating layer 31. A protective layer 42 corresponds to the protective layer 32 and has the same configuration as the protective layer 32. A recess 4a is similar to the recess 3a and accommodates the capacitor structure 6.

In the present embodiment, the stator 1 includes the capacitor structures 5, and the mover 2 includes the capacitor structures 6. Accordingly, either the capacitor structures 5 or the capacitor structures 6 correspond to the first structures and the other to the second capacitor structures of the present invention.

As shown in FIGS. 2 and 4, the power receiver 7 applies voltage to the capacitor structures 6 of the mover 2 from outside. The power receiver 7 has a plurality of sliding terminals 71. When the mover 2 rotates with respect to the stator 1, the sliding terminals 71 may individually maintain electrical conductivity while sliding with a plurality of sliding terminals 22 provided for the mover 2. Various conventional configurations are suitably applicable to the sliding terminals 71 and the sliding terminals 22. One example of such a configuration is a carbon brush.

As shown in FIG. 4, a controller 8 is used in an actuator system including the electrostatic actuator A1. The controller 8 includes a stator controller 81 and a mover controller 82, for example. In order for the stator controller 81 and the mover controller 82 to perform polarity switch control (switching control) for the capacitor structures 5 and 6, a detection device such as a rotary encoder (not illustrated) that detects the rotating angle of the mover 2 may be provided as appropriate. The stator controller 81 and the mover controller 82 may be configured as separate control modules, or may be configured as circuits having respective functions to perform in the single controller 8. In either of the configurations, the stator controller 81 and the mover controller 82 preferably have the same potential reference by, for example, being connected to a common ground line.

The stator controller 81 is connected to each of the counter electrodes 51 and the non-counter electrodes 52 of the capacitor structures 5. The stator controller 81 can appropriately change and set the charged state of the counter electrode 51 and the non-counter electrode 52 of each of the capacitor structures 5, and may include a power supply unit, a transformer, a switching unit, a control unit (e.g., CPU or microcomputer), a memory, and so on, as appropriate.

The mover controller 82 is connected to the counter electrode 61 and the non-counter electrode 62 of each of the capacitor structures 6 via the power receiver 7 (i.e., the sliding terminals 71) and the sliding terminals 22. The mover controller 82 can appropriately change and set the charged state of the counter electrode 61 and the non-counter electrode 62 of each of the capacitor structures 6, and may include a power supply unit, a transformer, a switching unit, a control unit (e.g., CPU or microcomputer), a memory, and so on, as appropriate.

With the stator controller 81 and the mover controller 82, it is possible to have a configuration where the polarity of each of the capacitor structures 5 and the capacitor structures 6 can be set freely. Other than this, it is also possible to have a configuration where only either the polarities of the capacitor structures 5 or the polarities of the capacitor structures 6 can be set freely.

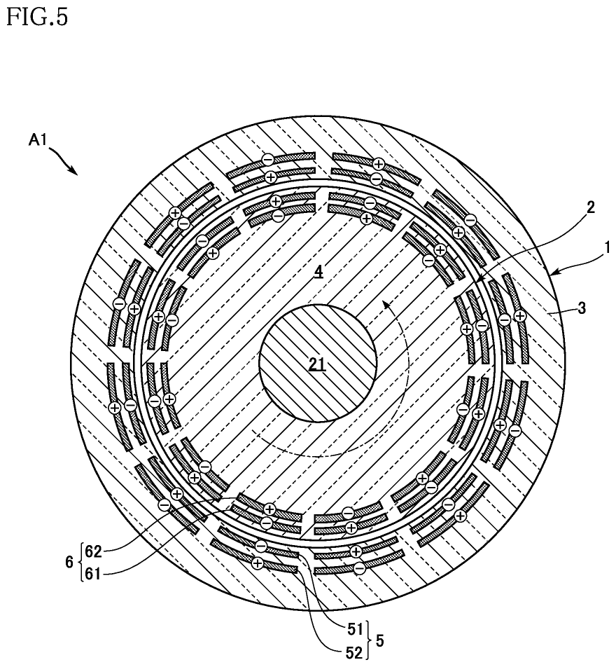

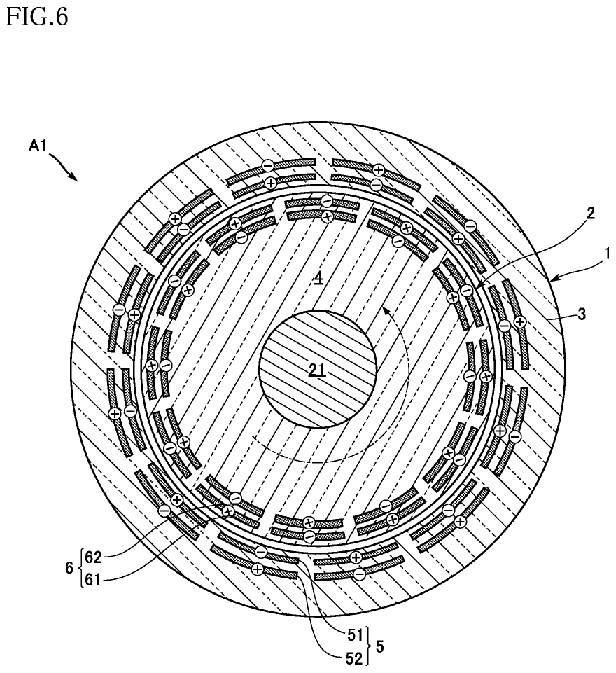

Next, an operational example of the electrostatic actuator A1 will be described with reference to FIGS. 5 and 6.

In FIG. 5, the polarities of adjacent ones of the capacitor structures 5 in the stator 1 are set to be opposite to each other by the stator controller 81. In other words, one counter electrode 51 is set to have positive polarity and a counter electrode 51 adjacent to the one counter electrode 51 is set to have negative polarity. Meanwhile, the polarities of adjacent ones of the capacitor structures 6 in the mover 2 are set to be opposite to each other by the mover controller 82. In other words, one counter electrode 61 is set to have positive polarity and a counter electrode 61 adjacent to the one counter electrode 61 is set to have negative polarity. A counter electrode 61, facing a counter electrode 51 having positive polarity in the radial direction, is set to have positive polarity, and a counter electrode 61, facing a counter electrode 51 having negative polarity in the radial direction, is set to have negative polarity. As a result, repulsive forces are generated between the counter electrodes 51 of the capacitor structures 5 and the counter electrodes 61 of the capacitor structures 6 that face each other. On the other hand, attractive forces are generated between the counter electrodes 51 that are adjacent to each other in the circumferential direction and between the counter electrodes 61 that are adjacent to each other in the circumferential direction.

For example, in the case of FIG. 5, the mover 2 will slightly move counterclockwise relative to the stator 1. The repulsive force and the attractive force generated between the counter electrodes 51 and the counter electrodes 61 then creates a drive force that causes the mover 2 to rotate counterclockwise. As a result, the mover 2 rotates counterclockwise, whereby the state illustrated in FIG. 6 is created. When the rotation continues, the counter electrodes 51 and the counter electrodes 61 that have been adjacent to each other in the circumferential direction in FIG. 5 come closest to each other and face each other. For example, when a counter electrode 51 passes by a counter electrode 61 having the opposite polarity (a counter electrode 61 attracted by an attractive force) for some distance in the circumferential direction, the polarities of either the capacitor structures 5 or the capacitor structures 6 are inverted. As a result, a repulsive force is generated between the counter electrodes 51 and the counter electrodes 61, whereby a state similar to the one illustrated in FIG. 5 is created. After that, the control described above is repeated so as to rotate the mover 2 and output a rotational force from the rotational shaft 21. When the rotating mover 2 is to be stopped, the polarity switch control by the stator controller 81 and the mover controller 82 may be stopped.

Next, the advantages of the electrostatic actuator A1 will be described.

According to the present embodiment, each of the capacitor structures 5 is configured with the counter electrode 51 and the non-counter electrode 52 separated by the dielectric layer 53. Therefore, when the counter electrode 51 and the non-counter electrode 52 have opposite polarities, they maintain their charged states. As such, in the rotation control illustrated in FIGS. 5 and 6, there is no need to perform processes such as applying voltage continuously from the stator controller 81 in order to make an arbitrary one of the counter electrodes 51 have a certain polarity as desired. Furthermore, charging the counter electrode 51 and the non-counter electrode 52 that form a capacitor structure 5 to have opposite polarities can be performed more smoothly than charging a single counter electrode 51 to have either one of the polarities. Suppose here that a counter electrode 51 is a single electrode not forming a capacitor structure and a counter electrode 61 having the same polarity as the counter electrode 51 approaches the counter electrode 51. In this case, the counter electrode 51 will be charged to have a polarity opposite from that of the counter electrode 61 due to the charging effect of the counter electrode 61. In the present embodiment, the counter electrodes 51 are paired with the non-counter electrodes 52 with the dielectric layers 53 therebetween to form the capacitor structures 5. This makes it possible to effectively suppress the charging effect of the counter electrodes 61 facing the counter electrodes 51. Thus, the electrostatic actuator A1 allows us to have an electrostatic actuator that is faster and with a higher output.

In the present embodiment, the mover 2 has the capacitor structures 6, and each of the stator 1 and the mover 2 are provided with capacitor structures. This makes it possible to charge the counter electrodes 61 with intended polarity more smoothly, as described above. It is also possible to maintain a more strongly charged state of the counter electrodes 61. This further facilitates increasing the speed and output of the actuator.

FIGS. 6 to 9 illustrates variations and another embodiment of the present invention. In these figures, elements that are the same as or similar to those in the above embodiment are provided with the same reference signs as in the above embodiment.

### First Variation of First Embodiment

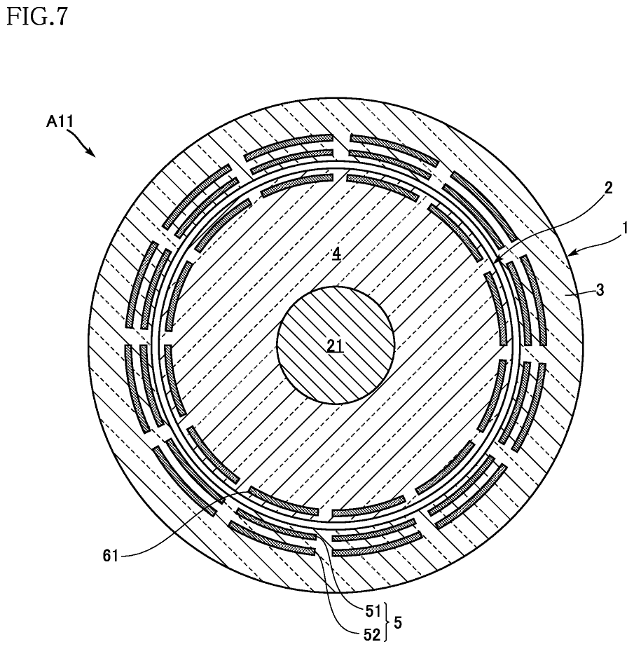

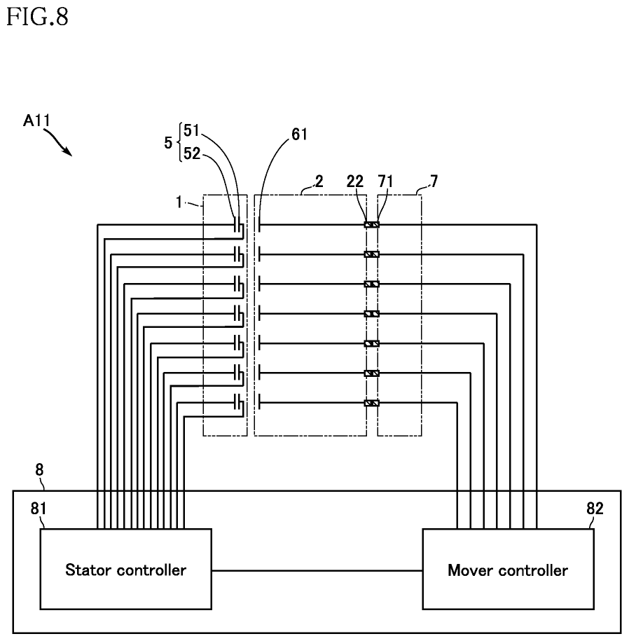

FIGS. 7 and 8 illustrate a first variation of the electrostatic actuator A1. According to an electrostatic actuator All of the present variation, a stator 1 includes a plurality of capacitor structures 5, and a mover 2 includes a plurality of counter electrodes 61.

The mover 2 has the counter electrodes 61 arranged along the circumferential direction, but does not have any electrodes that form capacitor structures (i.e., the non-counter electrodes 62 described in the above example). Accordingly, in the present variation, the capacitor structures 5 correspond to the first capacitor structures of the present invention, the counter electrodes 51 correspond to the first counter electrodes of the present invention, the non-counter electrodes 52 correspond to the first non-counter electrodes of the present invention, and the counter electrodes 61 correspond to the second counter electrodes of the present invention.

The present variation can also increase the speed and output of the actuator by means of the capacitor structures 5 in the stator 1. As can be understood from the present variation, the present invention is not limited to the configuration that includes both of the capacitor structures 5 and the capacitor structures 6.

### Second Variation of First Embodiment

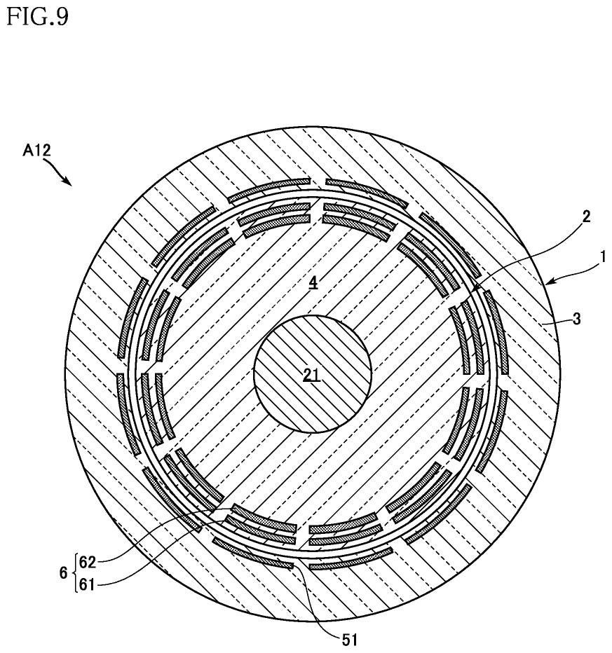

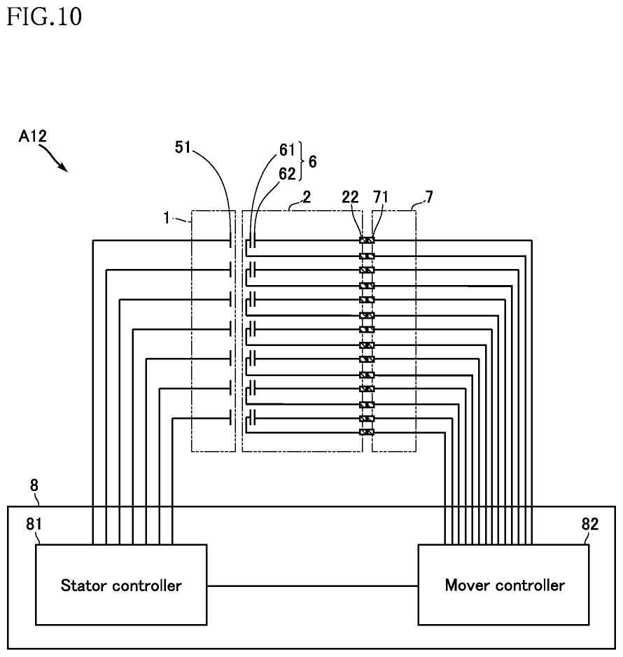

FIGS. 9 and 10 illustrate a second variation of the electrostatic actuator A1. According to an electrostatic actuator A12 of the present variation, a mover 2 includes a plurality of capacitor structures 6, and a stator 1 includes a plurality of counter electrodes 51.

The stator 1 has the counter electrodes 51 arranged along the circumferential direction, but does not have any electrodes that form capacitor structures (i.e., the non-counter electrodes 52 described in the above example). Accordingly, in the present variation, the capacitor structures 6 correspond to the first capacitor structures of the present invention, the counter electrodes 61 correspond to the first counter electrodes of the present invention, the non-counter electrodes 62 correspond to the first non-counter electrodes of the present invention, and the counter electrodes 51 correspond to the second counter electrodes of the present invention.

The present variation can also increase the speed and output of the actuator by means of the capacitor structures 5 in the stator 1. As can be understood from the present variation, the present invention may adopt a configuration where either the stator 1 or the mover 2 includes capacitor structures.

### Third Variation of First Embodiment

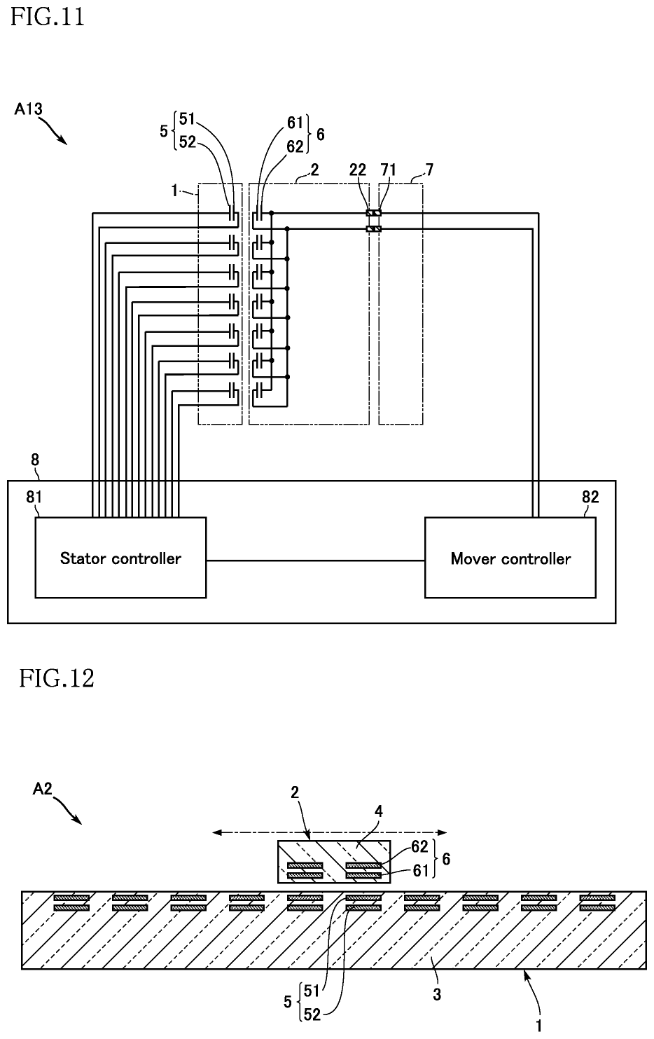

FIG. 11 illustrates a third variation of the electrostatic actuator A1. An electrostatic actuator A13 of the present variation has the cross-sectional structure illustrated in FIG. 2, for example, but the polarities of the capacitor structures 6 are set collectively. In other words, according to the capacitor structures 6 of the mover 2, the counter electrodes 61 are connected to each other, and the non-counter electrodes 62 are connected to each other. Accordingly, there are provided two sliding terminals 22 and two sliding terminals 71.

Even with such a variation, it is possible to control the drive of the electrostatic actuator A13 by detecting the relative rotating angle of the stator 1 and the mover 2 and controlling the polarities of the capacitor structures 5 according to the detected rotating angle. Furthermore, setting the polarities of the capacitor structures 6 collectively can reduce the number of sliding terminals 22 and the sliding terminals 71. Instead of the present variation, it is possible set the polarities of the capacitor structures 5 collectively.

### Second Embodiment

FIG. 12 illustrates a second embodiment of the present invention. An electrostatic actuator A2 of the present embodiment is configured as a linear actuator.

A support 3 of a stator 1 is elongated in the horizontal direction in the figure. A plurality of capacitor structures 5 are arranged along the upper surface of the support 3 in the horizontal direction in the figure.

A mover 2 is slidably supported by a rail member (not illustrated) or the like, for example, and is freely movable relative to the stator 1 in the horizontal direction in the figure. A support 4 of the mover 2 is smaller than the support 3 in the horizontal direction. The number of capacitor structures 6 is smaller than the number of capacitor structures 5. The number of capacitor structures 6 is two in the illustrated example but may be one, three, or more.

In the electrostatic actuator A2, the mover 2 can be moved relative to the stator 1 in the horizontal direction in the figure by switching the polarities of the capacitor structures 5 and the capacitor structures 6 with the use of, for example, the stator controller 81 and the mover controller 82 described above. In this way, the electrostatic actuator A2 can output the drive force from the mover 2 along the horizontal direction in the figure.

Any of the following configurations is applicable to the electrostatic actuator A2 as a variation: the configuration without the non-counter electrodes 62 illustrated in FIGS. 7 and 8; the configuration without the non-counter electrodes 52 illustrated in FIGS. 9 and 10; and the configuration illustrated in FIG. 11.

The present embodiment can also increase the speed and output of the electrostatic actuator A2. As can be understood from the present embodiment, the specific form of the electrostatic actuator according to the present invention is not particularly limited.

The electrostatic actuator according to the present invention is not limited to the foregoing embodiments. Various design changes can be made to the specific configurations of the elements of the electrostatic actuator according to the present invention.

1. An electrostatic actuator comprising a stator and a mover, the electrostatic actuator being driven by an attractive force and a repulsive force generated by an electric field between the stator and the mover,
wherein one of the stator and the mover includes a plurality of first capacitor structures each having a first counter electrode and a first non-counter electrode,
another one of the stator and the mover includes a plurality of second counter electrodes, and
the electrostatic actuator is driven by an attractive force and a repulsive force generated between the first counter electrodes and the second counter electrodes.

2. The electrostatic actuator according to claim 1, wherein the other one of the stator and the mover includes a plurality of second capacitor structures each having a second non-counter electrode and a different one of the second counter electrodes.

3. The electrostatic actuator according to claim 1, further comprising a rotational shaft that outputs a drive force,
wherein the mover has a circular shape as viewed along an axial direction of the rotational shaft, and is fixed to the rotational shaft,
the stator has a cylindrical shape having a central axis on the rotational shaft, and surrounds the mover, and
the plurality of first capacitor structures and the plurality of second counter electrodes are arranged in circles centering on the rotational shaft, so that the first counter electrodes and the second counter electrodes face each other.

4. The electrostatic actuator according to claim 1,
wherein the stator has a shape extending in a first direction,
the mover has a dimension smaller than the stator in the first direction, and is arranged to face the stator in a second direction perpendicular to the first direction, and
the plurality of first capacitor structures and the plurality of second counter electrodes are arranged along the first direction so that the first counter electrodes and the second counter electrodes face each other.
